(19) United States
(12) Patent Application Publication
(10) Pub. No.: US 2023/0267932 A1
(43) Pub. Date: Aug. 24, 2023

(54) DIALOGUE SYSTEM AND DIALOGUE UNIT

(71) Applicant: AISIN CORPORATION, Kariya (JP)

(72) Inventors: Shin OSUGA, Kariya-shi (JP); Godai TANAKA, Kariya-shi (JP); Ayana NABEKURA, Kariya-shi (JP); Ryota NAKANO, Kariya-shi (JP); Ryota WATANABE, Kariya-shi (JP); Tatsuya SATO, Kariya-shi (JP); Norihide KITAOKA, Toyohashi-shi (JP); Ryota NISHIMURA, Tokushima-shi (JP); Sunao HARA, Okayama-shi (JP); Kengo OHTA, Anan-shi (JP); Teruyuki ISHIKAWA, Tokyo-to (JP); Yuka ISHIKAWA, Tokyo-to (JP)

(73) Assignee: AISIN CORPORATION, Kariya (JP)

(21) Appl. No.: 18/169,925

(22) Filed: Feb. 16, 2023

(30) Foreign Application Priority Data
Feb. 21, 2022 (JP) 2022-024907

(51) Int. Cl. G10L 15/25; G06V 40/16

(52) U.S. Cl. CPC G10L 15/25; G06V 40/172

(57) ABSTRACT

A dialogue system that dialogues with a user includes an execution device configured to execute a detection process and a recognition process. The recognition process is a process of recognizing that the user talks to the dialogue system when a predetermined state is detected by the detection process. The detection process is a process of detecting the predetermined state using, as an input, an output signal of a camera that images the user. The predetermined state includes a state in which a mouth of the user moves.

### CROSS REFERENCE TO RELATED APPLICATIONS

This application is based on and claims priority under 35 U.S.C. § 119 to Japanese Patent Application 2022-024907, filed on Feb. 21, 2022, the entire content of which is incorporated herein by reference.

### TECHNICAL FIELD

This disclosure relates to a dialogue system and a dialogue unit.

### BACKGROUND DISCUSSION

JP 2011-215900A (Reference 1) discloses a multimodal dialogue device. The device identifies whether a user is having a dialogue with the dialogue device by inputting a voice feature and a feature related to a face direction of the user to an identification model, for example.

However, when determining whether the user is having a dialogue with the device based on the feature related to the face direction and the voice feature, the accuracy of the determination is not necessarily high.

### SUMMARY

According to an aspect of this disclosure, there is provided a dialogue system that dialogues with a user, the dialogue system including: an execution device configured to execute a detection process and a recognition process, in which the recognition process is a process of recognizing that the user talks to the dialogue system when a predetermined state is detected by the detection process, the detection process is a process of detecting the predetermined state using, as an input, an output signal of a camera that images the user, and the predetermined state includes a state in which a mouth of the user moves.

According to another aspect of this disclosure, there is provided a dialogue unit included in the dialogue system described above.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram showing a configuration of a dialogue system according to a first embodiment;

FIG. 2 is a flowchart showing a procedure of a process executed by the dialogue system according to the first embodiment;

FIG. 3 is a flowchart showing a procedure of a process executed by the dialogue system according to the first embodiment;

FIG. 4 is a diagram showing a display example of an agent and a panel according to the first embodiment;

FIG. 5 is a flowchart showing a procedure of a process executed by a dialogue system according to a second embodiment;

FIG. 6 is a flowchart showing a procedure of a process executed by a dialogue system according to a third embodiment;

FIG. 7 is a block diagram showing a configuration of a dialogue system according to a fourth embodiment; and

(a) and (b) of FIG. 8 are flowcharts showing a procedure of a process executed by the dialogue system according to the fourth embodiment.

### DETAILED DESCRIPTION

### First Embodiment

Hereinafter, a first embodiment will be described with reference to the drawings.

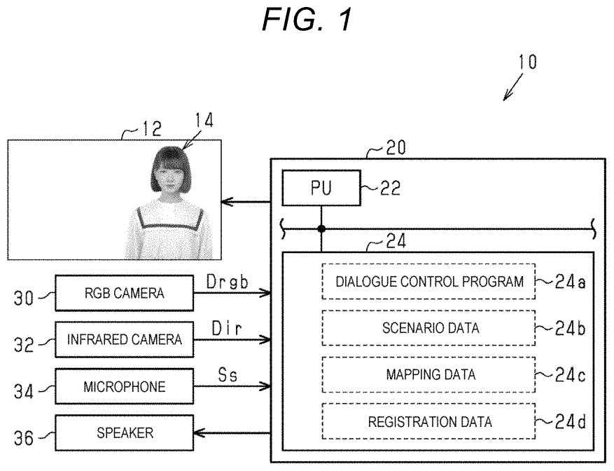

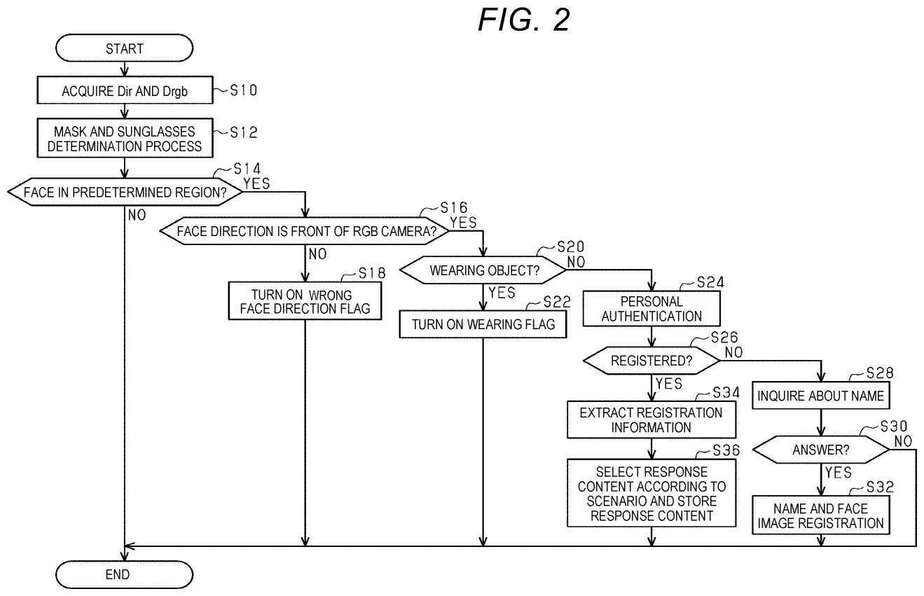

FIG. 1 shows a configuration of a dialogue system 10. The dialogue system 10 shown in FIG. 1 includes a display unit 12. The display unit 12 is a display panel including an LCD, an LED, or the like. An agent image 14 is displayed on the display unit 12. The agent image 14 is an image indicating an agent that is a virtual person who dialogues with a user.

A control device 20 controls an image displayed on the display unit 12 by operating the display unit 12. At this time, the control device 20 refers to RGB image data Drgb output by an RGB camera 30 in order to control the image. The RGB camera 30 is disposed toward a direction in which the user is assumed to be located. The RGB image data Drgb includes luminance data of each of three primary colors including red, green, and blue. In addition, the control device 20 refers to infrared image data Dir output by an infrared camera 32 in order to control the image. The infrared camera 32 is also disposed toward the direction in which the user is assumed to be located. In addition, the control device 20 refers to an output signal Ss of a microphone 34 in order to control the image. The microphone 34 is provided to sense a sound signal generated by the user.

The control device 20 outputs a voice signal by operating a speaker 36 according to an action of the agent image 14. The voice signal is a signal indicating a content uttered by the agent indicated by the agent image 14.

The control device 20 includes a PU 22 and a storage device 24. The PU 22 is a software processing device including at least one of a CPU, a GPU, a TPU, and the like. The storage device 24 stores scenario data 24b. The scenario data 24b includes a finite automaton. The PU 22 controls a dialogue between the user and the agent according to the scenario data 24b. In the following description, among processes executed by the control device 20, an “authentication process” and a “process related to user utterance detection” will be particularly described in detail.

### Authentication Process

FIG. 2 shows a procedure of a process related to user authentication. The process shown in FIG. 2 is implemented by the PU 22 repeatedly executing a dialogue control program 24a stored in the storage device 24 shown in FIG. 1, for example, in a predetermined cycle. In the following description, a step number of each process is expressed by a numeral prefixed with “S”.

In a series of processes shown in FIG. 2, the PU 22 first acquires the infrared image data Dir and the RGB image data Drgb (S10). Next, the PU 22 executes a determination process as to whether the user is wearing a mask and sunglasses (S12). This process is a process in which the PU 22 inputs the infrared image data Dir to a wear determination mapping to calculate a value of a determination result variable indicating whether there is a wearing object. Here, the wear determination mapping is one of mappings defined by mapping data 24c stored in the storage device 24 of FIG. 1. The wear determination mapping is, for example, a trained model that is trained using the infrared image data Dir and the corresponding value of the determination result variable as training data. The wear determination mapping may be implemented by, for example, a convolutional neural network (hereinafter referred to as CNN). Alternatively, for example, a Transfomer or the like may be used.

Next, the PU 22 determines whether a face of the user is located in a predetermined region in a region indicated by the RGB image data Drgb (S14). The predetermined region may be a center region of the region indicated by the RGB image data Drgb. This process can be executed by calculating coordinates of a predetermined position in, for example, a contour of the face. This process can be implemented by including, for example, in the mapping data 24c, data defining a contour output mapping for inputting the RGB image data Drgb and outputting the coordinates of the predetermined position. The contour output mapping is a trained model that is trained using the RGB image data Drgb and the corresponding coordinates of the predetermined position as the training data. The contour output mapping may be implemented by, for example, the CNN. Alternatively, for example, a Transfomer or the like may be used.

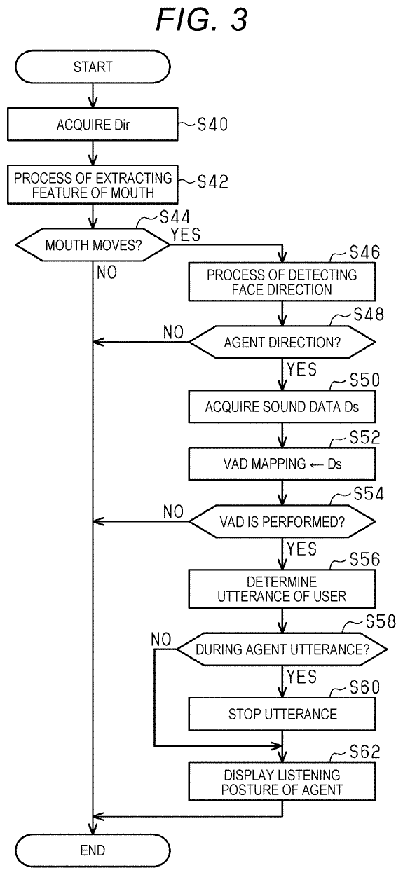

When it is determined that the face of the user is within the predetermined region (S14: YES), the PU 22 determines whether a face direction of the user is the front of the RGB camera 30 by using the infrared image data Dir as an input (S16). The face direction detection process here is the same as a process in S46 of FIG. 3 described below. When it is determined that the face direction is not the front (S16: NO), the PU 22 turns on a wrong face direction flag (S18). As a result, for example, it is possible to generate and deal with a state in which a transition is made to a state defined by the scenario data 24b when the wrong face direction flag is turned on. Specifically, for example, a transition destination state may be a state that defines an action such as the agent talking to the user to attract user attention and make the user look forward.

Meanwhile, when it is determined that the face direction is the front (S16: YES), the PU 22 determines whether it is determined that there is any wearing object in the process of S12 (S20). When it is determined that one of the mask and the sunglasses is worn (S20: YES), the PU 22 turns on a wearing flag (S22). As a result, for example, it is possible to generate and deal with a state in which a transition is made to a state defined by the scenario data 24b when the wearing flag is turned on. Specifically, for example, the transition destination state may be a state that defines an utterance process in which the agent asks the user to remove the wearing object.

Meanwhile, when it is determined that there is not any wearing object (S20: NO), the PU 22 executes personal authentication process of the user (S24). This process is a process in which the PU 22 determines whether a face image of the user matches any of face images included in registration data 24d stored in the storage device 24 shown in FIG. 1. This process can be implemented by, for example, template matching. When it is determined that there is no registration information (S26: NO), the PU 22 inquiries about a name by operating the speaker 36 (S28). Then, the PU 22 determines whether there is an answer (S30). When it is determined that there is an answer (S30: YES), the PU 22 associates the name with data of the face image and adds the name and the data of the face image to the registration data 24d of the storage device 24 (S32).

Meanwhile, when it is determined that there is the registration information (S26: YES), the PU 22 extracts the registration information from the registration data 24d (S34). When a response content according to the scenario data 24b is selected, the response content is stored in the registration data 24d (S36). In this manner, it is possible to avoid repeatedly uttering a content once talked to the user.

When the PU 22 makes a negative determination in the processes of S14 and S30 and when the processes of S18, S22, S32, and S36 are completed, the PU 22 temporarily ends the series of processes shown in FIG. 2.

### Process Related to User Utterance Detection

When having a dialogue with the user, it is desirable to accurately and quickly detect user utterance. Hereinafter, the process related to the user utterance detection will be described in detail.

FIG. 3 shows a procedure of the process related to the user utterance detection. The process shown in FIG. 3 is implemented by the PU 22 repeatedly executing the dialogue control program 24a in, for example, the predetermined cycle.

In a series of processes shown in FIG. 3, the PU 22 first acquires the infrared image data Dir (S40). Next, the PU 22 extracts a feature of a mouth based on the infrared image data Dir (S42). Here, the feature is an amount indicating a distance between an upper lip and a lower lip. This process can be implemented by calculating coordinates of a predetermined position of the upper lip and coordinates of a predetermined position of a lower lip. Here, the predetermined position may be, for example, a center portion of the lip. The coordinates of the predetermined position can be implemented by including data that defines a mouth coordinate output mapping in the mapping data 24c. The mouth coordinate output mapping is a trained model that outputs coordinates of a predetermined position. The mouth coordinate output mapping is trained using, for example, the infrared image data Dir and the corresponding coordinates of the predetermined position as the training data. The mouth coordinate output mapping may be implemented by, for example, the CNN. Alternatively, for example, the Transfomer or the like may be used.

Next, the PU 22 determines whether there is a mouth movement according to a determination as to whether the amount indicating the distance between the upper lip and the lower lip is equal to or larger than a predetermined value (S44). This process is a process of determining whether the user moves the mouth for utterance. In the process of S44, it is determined that the user moves the mouth for utterance when the amount indicating the distance between the upper lip and the lower lip is equal to or larger than the predetermined value. When it is determined that there is a mouth movement (S44: YES), the PU 22 executes a process of detecting the face direction of the user (S46). Here, the PU 22 detects the face direction by shape model fitting. Specifically, the PU 22 calculates coordinates of a predetermined feature point of the face using a regression model. Then, the PU 22 calculates the face direction by fitting the calculated coordinates of the feature point to a predetermined shape model. This process can be implemented by including the regression model and the shape model in the mapping data 24c.

Then, the PU 22 determines whether the face direction of the user is an agent direction (S48). When it is determined that the face direction is the agent direction (S48: YES), the PU 22 acquires sound data Ds by converting the analog output signal Ss into the digital sound data Ds (S50). Then, the PU 22 inputs the sound data Ds to a VAD mapping, thereby calculating a value of a variable indicating whether the sound data Ds is in a voice detection section (S52). The VAD mapping is a trained model that outputs the value of the variable indicating whether the sound data Ds is in the voice detection section based on time-series data of the sound data Ds. The VAD mapping is one of mappings defined by the mapping data 24c. The VAD mapping is implemented using, for example, a hidden Markov model (hereinafter referred to as HMM).

When it is determined that the sound data Ds is in the voice detection section (S54: YES), the PU 22 determines that the user is uttering toward the dialogue system 10 (S56). Then, the PU 22 determines whether the agent is uttering (S58). “The agent is uttering” means a state in which a voice signal is output from the speaker 36 according to the action of the agent image 14. When it is determined that the agent is uttering (S58: YES), the PU 22 stops the utterance (S60).

When the process of S60 is completed and when a negative determination is made in the process of S58, the PU 22 operates the display unit 12 to display an image of a listening posture as the agent image 14 (S62). The listening posture includes a nodding action. The listening posture may also include a posture in which the face of the user is gazed at.

When the process of S62 is completed and when the PU 22 makes a negative determination in the processes of S44, S48 and S54, the PU 22 temporarily ends the series of processes shown in FIG. 3. Here, effects of the present embodiment will be described.

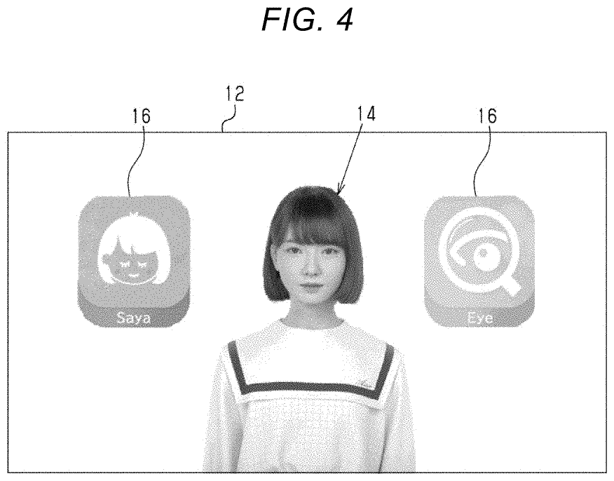

FIG. 4 shows a display example of an image on the display unit 12. FIG. 4 shows an example in which two panels 16 are displayed in addition to the agent image 14. Here, the PU 22 causes the agent represented by the agent image 14 to explain what happens when selecting each of the two panels 16 according to the scenario data 24b. That is, the PU 22 operates the speaker 36 to execute the utterance process indicating a content of the explanation, and operates the display unit 12 to sequentially display images of the agent talking.

Here, for example, the PU 22 causes the agent to explain a shift to a left panel by looking at the left panel 16, uttering “left panel”, or pointing at the left panel 16. In addition, for example, the PU 22 causes the agent to explain a shift to a right panel by looking at the right panel 16, uttering “right panel”, or pointing at the right panel 16. Accordingly, when the user desires to shift to the left panel, the user looks at the left panel 16, utters “left panel”, or points at the left panel 16.

Here, for example, when the user utters “left panel” after the agent explains a method of selecting the left panel and before the agent explains a method of selecting the right panel 16, the agent immediately takes the listening posture. That is, when the user utters “left panel”, the mouth of the user moves, and thus the PU 22 makes a positive determination in the process of S44. When the user hears the explanation of the agent and utters “left panel”, the face direction of the user is the agent direction. Therefore, the PU 22 makes a positive determination in the process of S48. In addition, when the user utters “left panel”, the PU 22 determines that the utterance is in a voice section. Therefore, the PU 22 determines that the user utters, and sets the agent to the listening posture. Therefore, the user can recognize that his/her request is accepted.

Further, for example, when the user utters “left panel” while the agent is explaining the method of selecting the right panel 16 after explaining the method of selecting the left panel, the agent stops explaining and takes the listening posture. Therefore, the user can recognize that his/her request is accepted.

Further, for example, when the user points at the left panel 16 while the agent is explaining the method of selecting the right panel 16 after explaining the method of selecting the left panel, the agent stops explaining.

According to the present embodiment described above, the following effects are further obtained.

(1) The PU 22 determines that the user utters under a condition that the mouth moves, in addition to a condition for determining that the utterance is in the voice section. As a result, even when it is erroneously determined that the utterance is in the voice section due to noise, it is possible to prevent an erroneous determination that the user utters. Therefore, it is possible to prevent an occurrence of barge-in in which the user interrupts the utterance of the agent in response to the agent stopping the utterance.

(2) A detection result of the voice section detection is included in an input corresponding to the output signal Ss among inputs of the determination processes as to whether the user utters. As a result, it is possible to reduce a calculation load of the determination process, for example, as compared with a case of taking into consideration of a content obtained by converting the output signal into text data by voice recognition. Therefore, the determination process can be quickly completed.

### Second Embodiment

Hereinafter, a second embodiment will be described with reference to the drawings, focusing on differences from the first embodiment.

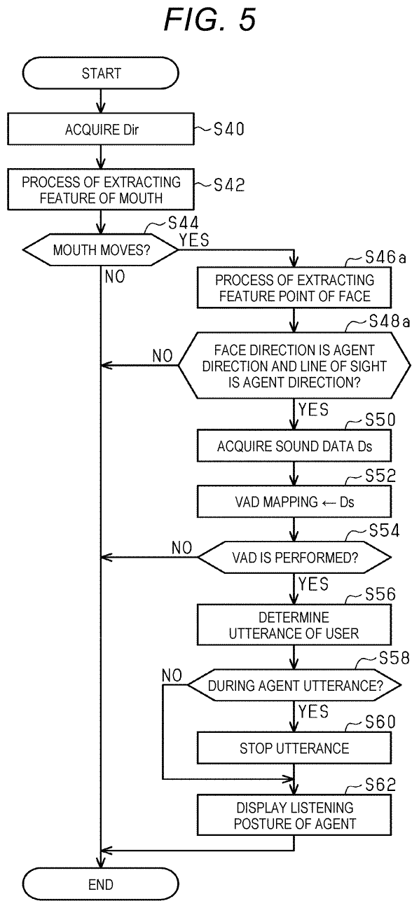

FIG. 5 shows a procedure of a process related to user utterance detection according to the present embodiment. The process shown in FIG. 5 is implemented by the PU 22 repeatedly executing the dialogue control program 24a in, for example, a predetermined cycle. In FIG. 5, the same step numbers are assigned to the processes corresponding to the processes shown in FIG. 3 for the sake of convenience.

In a series of processes shown in FIG. 5, when a positive determination is made in the process of S44, the PU 22 extracts a feature point of the face (S46a). This process is a process of calculating coordinates of a predetermined feature point of the face using the regression model. This process can be implemented by including the regression model described above in the mapping data 24c. The regression model is a trained model that is trained using the infrared image data Dir and the coordinates of the feature point as the training data.

Next, the PU 22 determines whether a logical product of the following condition (A) and condition (B) is true (S48a).

Condition (A): a condition that the face direction of the user is the agent direction. The determination process as to whether this condition is satisfied is the same as the processes of S46 and S48 of FIG. 3.

Condition (B): a condition that the line of sight of the user is the agent direction. Here, the PU 22 estimates a direction of the line of sight by the shape model fitting using a 3D model of eyes. This process can be implemented by including, in the mapping data 24c, the 3D model of the eyes and a mapping for outputting a shape model fitting result using the feature point as an input.

When it is determined that the logical product is true (S48a: YES), the PU 22 proceeds to the process of S50, and when it is determined that the logical product is false (S48a: NO), the PU 22 temporarily ends the series of processes shown in FIG. 5.

As described above, in the present embodiment, the condition that the line of sight of the user is the agent direction is added as the condition for determining that the user utters. Accordingly, it is possible to determine whether the user utters with higher accuracy.

### Third Embodiment

Hereinafter, a third embodiment will be described with reference to the drawings, focusing on differences from the first embodiment.

In the first embodiment, when the user performs a pointing action such as pointing at the left panel 16, the agent does not take the listening posture. However, it is also assumed that the user utters “left panel” or the like at the same time as performing the pointing action. In the present embodiment, a process in such a case is separately provided.

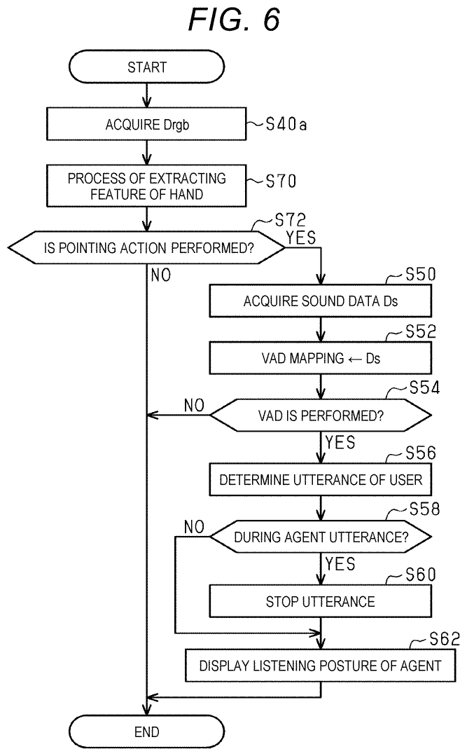

FIG. 6 shows a procedure of a process related to user utterance detection according to the present embodiment. The process shown in FIG. 6 is implemented by the PU 22 repeatedly executing the dialogue control program 24a in, for example, a predetermined cycle. In FIG. 6, the same step numbers are assigned to the processes corresponding to the processes shown in FIG. 3 for the sake of convenience.

In a series of processes shown in FIG. 6, the PU 22 first acquires the RGB image data Drgb (S40a). Next, the PU 22 receives the RGB image data Drgb as an input and extracts a feature point of a hand (S70). This process can be implemented by inputting the RGB image data Drgb to a regression model that outputs coordinates of the feature point of the hand. Here, data that defines the regression model is one piece of data defined by the mapping data 24c. This regression model is a trained model that is trained using the RGB image data Drgb and the coordinates of the feature point of the hand as the training data.

Next, the PU 22 determines whether the user is pointing at a predetermined region of the display unit 12 (S72). Here, in the example shown in FIG. 4, the predetermined regions are a display region of the left panel 16 and a display region of the right panel 16. This process is performed by a shape model fitting using the feature point. Specifically, the process can be implemented by including, in the mapping data 24c, a shape model of the hand and a mapping for identifying a pointing direction by minimizing a difference between the feature point and the shape model. When it is determined that the pointing action is performed (S72: YES), the PU 22 proceeds to the process of S50, and when it is determined that the pointing action is not performed (S72: NO), the PU 22 temporarily ends the series of processes shown in FIG. 6.

### Fourth Embodiment

Hereinafter, a fourth embodiment will be described with reference to the drawings, focusing on differences from the first embodiment.

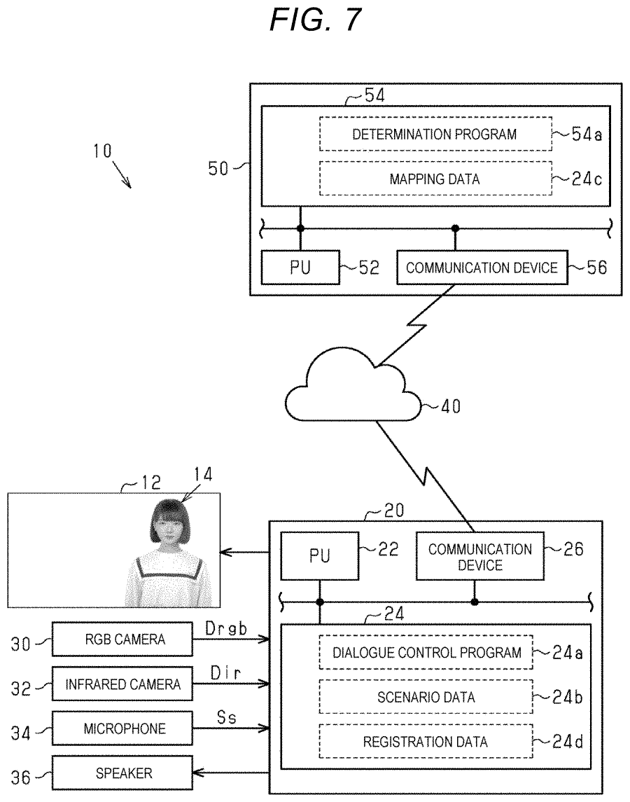

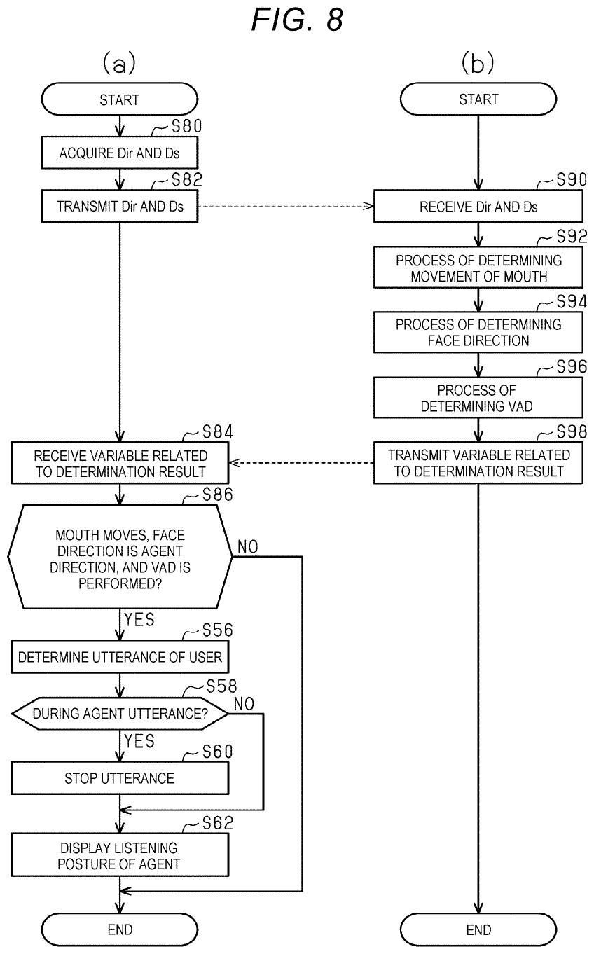

FIG. 7 shows a configuration of a dialogue system according to the present embodiment. In FIG. 7, members corresponding to the members shown in FIG. 1 are denoted by the same reference numerals for convenience. As shown in FIG. 7, the control device 20 includes a communication device 26. The communication device 26 can communicate with a backend unit 50 via a network 40. The network 40 is preferably a global network such as the Internet.

The backend unit 50 executes an arithmetic process using data transmitted from the control device 20 as an input. The backend unit 50 includes a PU 52, a storage device 54, and a communication device 56. The PU 52 is a software processing device including at least one of a CPU, a GPU, a TPU, and the like. The storage device 54 stores the mapping data 24c.

FIG. 8 shows a procedure of a process executed by the dialogue system 10 according to the present embodiment. A process shown in (a) of FIG. 8 is implemented by the PU 22 repeatedly executing the dialogue control program 24a stored in the storage device 24 shown in FIG. 7, for example, in a predetermined cycle. A process shown in (b) of FIG. 8 is implemented by the PU 52 repeatedly executing a determination program 54a stored in the storage device 54 of FIG. 7, for example, in a predetermined cycle. In FIG. 8, the same step numbers are assigned to the processes corresponding to the processes shown in FIG. 3 for the sake of convenience. Hereinafter, the process shown in FIG. 8 will be described according to a time series of the process executed by the dialogue system 10.

In a series of processes shown in (a) of FIG. 8, the PU 22 of the control device 20 first acquires the infrared image data Dir and the sound data Ds (S80). Next, the PU 22 transmits the infrared image data Dir and the sound data Ds to the backend unit 50 by operating the communication device 26 (S82).

Meanwhile, as shown in (b) of FIG. 8, the PU 52 of the backend unit 50 receives the infrared image data Dir and the sound data Ds (S90). Then, the PU 52 uses the infrared image data Dir to execute a process of determining the movement of the mouth, which is the same process as the processes of S42 and S44 of FIG. 3 (S92). In addition, the PU 52 uses the infrared image data Dir to execute a process of determining the face direction, which is the same process as the processes of S46 and S48 of FIG. 3 (S94). Further, the PU 52 uses the sound data Ds to execute the VAD process which is the same process as the processes of S52 and S54 of FIG. 3 (S96). Then, the PU 52 operates the communication device 56 to transmit variables related to the determination result of the processes of S92 to S96 to the control device 20 (S98). The variables related to the determination result are a variable indicating whether the mouth moves, a variable indicating the face direction, and a variable indicating whether the VAD is performed. When a process of S98 is completed, the PU 52 temporarily ends the series of processes shown in (b) of FIG. 8.

Meanwhile, as shown in (a) of FIG. 8, the PU 22 of the control device 20 receives the determination result transmitted in the process of S98 (S84). Then, the PU 22 determines whether a logical product of the condition (A), the following condition (C), and the following condition (D) is true (S86).

Condition (C): a condition that the mouth the user moves.

Condition (D): a condition that the VAD is performed.

When it is determined that the logical product is true (S86: YES), the PU 22 executes the processes of S56 to S62. Meanwhile, when it is determined that the logical product is false (S86: NO) and when the process of S62 is completed, the PU 22 temporarily ends the series of processes shown in (a) of FIG. 8.

As described above, in the present embodiment, the processes corresponding to the processes of S42, S44, S46, S48, S52, and S54 in FIG. 3 are executed by the backend unit 50. As a result, a calculation load of the control device 20 can be reduced. In addition, if the backend unit 50 is a device that collects big data, it is also possible to enhance the data to be collected.

The processes executed by the backend unit 50 are not limited to the processes corresponding to the processes of S42, S44, S46, S48, S52, and S54 in FIG. 3. In the present embodiment, in particular, it is assumed that a process of converting the sound data Ds into the text data and a process of executing morphological analysis on the text data are executed by the backend unit 50. The text data subjected to the morphological analysis is transmitted from the backend unit 50 to the control device 20. The PU 22 of the control device 20 determines a response sentence and an action of the agent based on the text data subjected to the morphological analysis and the scenario data 24b.

### Correspondence Relationship

A correspondence relationship between matters in the above embodiments and matters described below in the section “Solution to Problem” is as follows. In the following, the correspondence relationship is shown for each of the numbers assigned to the solutions described below in the section “Solution to Problem”. [1-3] The execution device corresponds to the PU 22 in FIG. 1 or the PUs 22 and 52 in FIG. 7. The detection process corresponds to the processes of S42 to S54 in FIG. 3, the processes of S42, S44, S46a, S48a, and S50 to S54 in FIG. 5, the processes of S70, S72, and S50 to S54 in FIG. 6, and the processes of S92 to S96 in FIG. 8. A recognition process corresponds to the process of S56. [4] The voice section detection process corresponds to the processes of S50 and S52 in FIGS. 3, 5, and 6 and the processes of S96 in FIG. 8. [5] The display process corresponds to the process of S62. [6] The utterance process corresponds to the processes of S28 and S36. The stop process corresponds to the process of S60. [7] The registration process corresponds to the process of S32. The history information association process corresponds to the process of S36. The utterance process corresponds to the process of S36. The authentication process corresponds to the process of S24. [8, 9] The first execution device corresponds to the PU 22 in FIG. 7. The second execution device corresponds to the PU 52 in FIG. 7. The dialogue unit corresponds to the control device 20. The backend unit corresponds to the backend unit 50. The first communication device corresponds to the communication device 26 in FIG. 7. The second communication device corresponds to the communication device 56 in FIG. 7. The second storage device corresponds to the storage device 54. The mapping data corresponds to the mapping data 24c. The variable used for determining whether the user is in a predetermined state corresponds to variables indicating the coordinates of the predetermined position of the upper lip, the coordinates of the predetermined position of the lower lip, the coordinates of the feature point of the face, and the face direction. The variable related to the determination result corresponds to the variable indicating whether the mouth moves and the variable indicating the face direction. The output signal acquisition process corresponds to the process of S80. The image data transmission process corresponds to the process of S82. The image data receiving process corresponds to the process of S90. The state determination process corresponds to the processes of S92 and S94. The determination result transmission process corresponds to the process of S98. The determination result receiving process corresponds to the process of S84.

### Other Embodiments

The present embodiment can be modified and implemented as follows. The present embodiment and the following modifications can be implemented in combination with each other within a technically consistent range.

State in which Line of Sight is Directed to Dialogue System

A condition for determining that the line of sight is directed to the dialogue system is not limited to the condition exemplified in the above embodiments. For example, the condition (B) may be replaced with a condition that the line of sight of the user is directed to the display unit 12. However, the condition for determining that the line of sight is directed to the dialogue system is not limited to the condition that the line of sight of the user is directed to a display region of the display device. For example, when the dialogue unit does not include the display device as will be described in the section “Dialogue Unit” below, a condition that the line of sight of the user is directed to the microphone 34 may be set as the condition for the above determination.

### Predetermined State

The predetermined state serving as a condition for recognizing that the user talks to the agent is not limited to the state exemplified in the above embodiments. For example, the predetermined state may be a state in which a logical product of the state in which the mouth moves and the state in which the VAD is performed is true. In addition, for example, the predetermined state may be a state in which a logical product of the state in which the mouth moves, the state in which the line of sight is directed to the dialogue system, and the state in which the VAD is performed is true. In addition, for example, the predetermined state may be a state in which a logical product of the state in which the line of sight is directed to the dialogue system and the state in which the VAD is performed is true. In addition, for example, the predetermined state may be a state in which a logical product of the state in which the face direction is the agent direction, the state in which the line of sight is directed to the dialogue system, and the state in which the VAD is performed is true. In addition, for example, in the process of FIG. 7, the predetermined state may be a state in which a logical product of the state in which the line of sight is directed to the dialogue system, the state in which the panel is pointed by a finger, and the state in which the VAD is performed is true. In addition, for example, in the process of FIG. 7, the predetermined state may be a state in which a logical product of the state in which the mouth moves, the state in which the line of sight is directed to the dialogue system, the state in which the panel is pointed by a finger, and the state in which the VAD is performed is true.

The predetermined state does not have to include the state in which the VAD is performed. For example, when the state in which the mouth moves is detected, it may be determined that the state is the predetermined state, and the PU 22 may set the agent to the listening posture. However, in this case, when the VAD is not performed for a predetermined period thereafter, the PU 22 may cancel the listening posture of the agent. In this case, the PU 22 may operate the speaker 36 to output a voice signal having a content for confirming intention of the utterance, such as “what did you say” to the user after the cancellation.

### Detection Process

(a) Detection of State in which Mouth Moves

In the above embodiments, the infrared image data Dir is used as the input of the regression model that outputs coordinate values of the predetermined position of the contour of the mouth. However, the image data is not limited thereto. For example, the RGB image data Drgb may be used.

For example, the state in which the mouth moves may be detected using an identification model that determines whether the mouth moves according to time-series data of image data including the mouth. As the identification model, a regression coupled neural network (hereinafter referred to as RNN) or the like may be used. In this case, the image data input to the identification model at one time is data imaged at one timing, but one output value is calculated with reference to not only the latest image data but also the past image data. However, the identification model is not limited to the RNN. For example, a neural network using a caution mechanism, such as a Transfomer, may be used. In this case, it is possible to obtain a model in which a predetermined number of pieces of image data imaged at timings adjacent to each other may be input at one time to calculate an output value. The identification model in the case of using the time series data does not have to be the neural network. For example, after features of the respective pieces of image data constituting the time series data are extracted, it may be determined whether the mouth moves by inputting the extracted features to a support vector machine.

(b) Detection of State in which Line of Sight is Directed to Dialogue System

In the above embodiments, the infrared image data Dir is used as the input of the regression model that outputs coordinate values of predetermined feature points of contours of the eyes, the mouth, the nose, and the like. However, the image data is not limited thereto. For example, the RGB image data Drgb may be used.

A method of estimating the line of sight is not limited to a model-based method such as the shape model fitting. For example, an appearance-based method using a trained model that outputs a gaze point using image data as an input may be used. Here, as the trained model, for example, a linear regression model, a Gaussian process regression model, the CNN, or the like may be used.

(c) Method of Detecting Section in which Voice is Output

The trained model for executing the VAD is not limited to the model using the HMM. For example, the trained model may be a support vector machine that identifies a section in which a voice is output by inputting time series data of a feature at one time. In addition, for example, an identification model using the RNN or the like may be used.

The method of detecting the section in which the voice is output is not limited to the method using the trained model. For example, the method may be a process of determining whether a sound pressure level having a frequency component characteristic of the voice is equal to or higher than a threshold value. At this time, an input of the process of detecting the section in which the voice is output is not limited to the digital sound data Ds, and may be the analog output signal Ss itself. In other words, the process of detecting the section in which the voice is output may be executed by an analog process. This process can be implemented by using a dedicated analog circuit or the like.

(d) Detection of State in which Voice is Output

The detection of the state in which the voice is output is not limited to the VAD. For example, the process may be a process of determining whether a word is actually spoken by a voice recognition process.

(e) Detection of State in which Face Direction is Directed to Dialogue System

In the above embodiments, the infrared image data Dir is used as the input of the regression model that outputs coordinate values of predetermined feature points of contours of the eyes, the mouth, the nose, and the like. However, the image data is not limited thereto. For example, the RGB image data Drgb may be used.

For example, the state in which the face direction is the agent direction may be detected using an identification model that determines whether the face direction is the agent direction using image data as an input. Here, as the identification model, a neural network or the like can be used.

### Posture of Listening to User

The posture of listening to the user does not have to include the nodding action. For example, the posture may be a posture of looking at the user without moving.

### Utterance Process

The utterance process is not limited to a process executed according to the scenario data 24b. For example, the process may be a process of uttering a response sentence obtained by inputting text data indicating an utterance content of the user to the trained model. In this case, when personal authentication is performed, the content once talked may also not be set as an utterance target again.

### Registration Process

In FIG. 2, the registration process is executed under a condition that the user gives his/her name, but the disclosure is not limited thereto. For example, even when the name of the user is not known, a face image of the user may be registered in association with an automatically generated identification symbol at a stage when the face image of the user is obtained.

### Backend Unit

The process executed by the backend unit 50 is not limited to the process shown in the system shown in FIG. 7. For example, the VAD may be performed by the control device 20. For example, in addition to the determination process as to whether the face direction is the agent direction and the determination process as to whether the mouth moves, the backend unit 50 may perform the determination process as to whether the line of sight is directed to the dialogue system. In addition, for example, the backend unit 50 may execute only one of three processes including the determination process as to whether the face direction is the agent direction, the determination process as to whether the mouth moves, and the determination process as to whether the line of sight is directed to the dialogue system. In addition, for example, the backend unit 50 may execute any two of the above-described three processes.

The number of backend units does not have to be one. For example, a backend unit that executes the process of converting the sound data Ds into the text data and a backend unit that executes the determination process as to whether the mouth moves may be disposed at different places.

### Display Device

The display device is not limited to the device including the display unit 12. For example, the display device may be a display device using holography. In addition, for example, a head-up display or the like may be used.

### Dialogue Unit

The dialogue unit does not have to include the display device.

### Dialogue System

The dialogue system does not have to include the backend unit 50.

### Execution Device

The execution device is not limited to a device that executes software processing, such as a CPU, a GPU, and a TPU. For example, a dedicated hardware circuit that performs hardware processing on at least a part of what is software-processed in the above embodiment may be provided. Here, the dedicated hardware circuit may be, for example, an ASIC or the like. That is, the execution device may have any one of the following configurations (a) to (c). (a) The execution device includes a processing device that executes all of the above processes according to a program, and a program storage device that stores the program. (b) The execution device includes a processing device that execute a part of the above processes according to a program, a program storage device, and a dedicated hardware circuit that executes the remaining processes. (c) The execution device includes a dedicated hardware circuit that executes all the processes described above. Here, there may be multiple software execution devices each including a processing device; and a program storage device, and there may be multiple dedicated hardware circuits.

### Solution to Problem

Hereinafter, solutions to the related art problems and effects thereof will be described.

1. A dialogue system that dialogues with a user, the dialogue system including: an execution device configured to execute a detection process and a recognition process, in which the recognition process is a process of recognizing that the user talks to the dialogue system when a predetermined state is detected by the detection process, the detection process is a process of detecting the predetermined state using, as an input, an output signal of a camera that images the user, and the predetermined state includes a state in which a mouth of the user moves.

In the above configuration, it is recognized that the user talks to the dialogue system under the condition that the predetermined state is detected. Here, since the predetermined state includes the state in which the mouth of the user moves, utterance of the user can be determined with a high probability. Therefore, by determining that the user talks to the dialogue system based on this state, it is possible to improve determination accuracy.

2. The dialogue system according to the above 1, in which the predetermined state further includes at least one of two states including a state in which a line of sight of the user is directed toward the dialogue system and a state in which the user points at the dialogue system.

In the above configuration, when the predetermined state includes the state in which a line of sight of the user is directed toward the dialogue system, it is possible to infer the user's intention to have a dialogue with the dialogue system. Therefore, by determining that the user talks to the dialogue system based on this state, it is possible to improve determination accuracy. When the predetermined state includes the state in which the user points at the dialogue system, it is possible to infer the user's intention to try to communicate with the dialogue system. Therefore, by determining that the user talks to the dialogue system based on this state, it is possible to improve determination accuracy.

3. The dialogue system according to the above 1 or 2, in which the detection process is a process of detecting the predetermined state using, as an input, an output signal of a microphone in addition to the output signal of the camera, and the predetermined state includes a state in which both the state in which the mouth of the user moves and a state in which a voice is output are established.

In the above configuration, the predetermined state includes the state in which both the state in which the mouth of the user moves and the state in which a voice is output are established. Therefore, it is possible to identify a situation in which a probability that the output of the voice is from the user is high or a situation in which a probability that the output of the voice is from the user toward the dialogue system is high.

4. The dialogue system according to the above 3, in which the detection process includes a voice section detection process of detecting a section in which the voice is output, and the state in which the voice is output in the predetermined state is a state in which the voice is determined to be in a voice section by the voice section detection process.

In the above configuration, the state in which the voice is determined to be in the voice section is detected as the state in which the voice is output. Therefore, it is possible to reduce a calculation load of the determination process as to whether the state is the predetermined state, for example, as compared with a case of taking into consideration a content obtained by converting the output signal into text data by voice recognition. Therefore, the determination process as to whether the state is the predetermined state can be quickly completed.

5. The dialogue system according to any one of the above 1 to 4, in which the execution device further executes a display process of displaying an agent image by operating a display device, the agent image is an image of an agent, the agent is a person who dialogues with the user, and the display process includes a process of displaying an image indicating the agent taking a posture listening to the user when it is recognized by the recognition process that the user talks to the dialogue system.

In the above configuration, when it is recognized that the user talks to the dialogue system, the agent takes a listening posture, and thus the user can recognize that the agent is listening to him/her.

6. The dialogue system according to any one of the above 3 to 5, in which the execution device further executes an utterance process of talking to the user by operating the speaker, and a stop process of stopping the utterance process when it is recognized by the recognition process that the user talks to the dialogue system during execution of the utterance process.

In the above configuration, when it is recognized that the user talks to the dialogue system, the utterance process is stopped. Here, the recognition process in which the user talks to the dialogue system is performed with high accuracy since the recognition process is based on the predetermined state. Therefore, it is possible to prevent the execution of the stop process when noise is erroneously detected as being in the state in which the voice is output. When the stop process is executed in a case where noise is erroneously detected as being in the state in which the voice is output, there is a concern that a so-called barge-in, in which the user talks, may occur. Therefore, in the above configuration, it is possible to prevent the occurrence of the barge-in.

7. The dialogue system according to the above 6, further including: a storage device, in which the execution device further executes a registration process, an authentication process, and a history information association process, the registration process is a process of storing information on a face image of the user in the storage device by using the output signal of the camera as an input, the authentication process includes a process of determining whether the user who is imaged by the camera is the user stored in the storage device, using the output signal of the camera as an input, the history information association process is a process of storing, in the storage device, history information on communication between the user stored in the storage device and the dialogue system, and the utterance process includes a process of determining a content of utterance based on the history information associated with the user authenticated by the authentication process.

In the above configuration, since the content of the utterance is determined according to the history information, it is possible to prevent the content once talk to the user from being repeated.

8. The dialogue system according to any one of the above 1 to 7, in which the execution device includes a first execution device and a second execution device, the dialogue system further includes a dialogue unit and a backend unit, the dialogue unit includes the first execution device and a first communication device, the backend unit includes the second execution device, a second storage device, and a second communication device, the second storage device stores mapping data, the detection process includes an output signal acquisition process, an image data transmission process, an image data receiving process, a state determination process, a determination result transmission process, and a determination result receiving process, the output signal acquisition process is a process in which the first execution device acquires the output signal of the camera, the image data transmission process is a process in which the first execution device operates the first communication device to transmit image data corresponding to the output signal of the camera to the backend unit, the image data receiving process is a process in which the second execution device receives the image data, the mapping data is data that defines a determination mapping, the determination mapping is a process of outputting a variable used for determining whether the image data is in the predetermined state, using the image data as an input, the state determination process is a process in which the second execution device inputs the image data to the determination mapping to calculate a variable related to a determination result of whether the image data is in the predetermined state, the determination result transmission process is a process in which the second execution device operates the second communication device to transmit the variable related to the determination result to the dialogue unit, and the determination result receiving process is a process in which the first execution device receives the determination result.

The above load can be reduced.

9. The dialogue unit included in the dialogue system according to 8 described above.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A dialogue system that dialogues with a user, the dialogue system comprising:
an execution device configured to execute a detection process and a recognition process, wherein
the recognition process is a process of recognizing that the user talks to the dialogue system when a predetermined state is detected by the detection process,
the detection process is a process of detecting the predetermined state using, as an input, an output signal of a camera that images the user, and
the predetermined state includes a state in which a mouth of the user moves.

2. The dialogue system according to claim 1, wherein
the predetermined state further includes at least one of two states including a state in which a line of sight of the user is directed toward the dialogue system and a state in which the user points at the dialogue system.

3. The dialogue system according to claim 1, wherein
the detection process is a process of detecting the predetermined state using, as an input, an output signal of a microphone in addition to the output signal of the camera, and
the predetermined state includes a state in which both the state in which the mouth of the user moves and a state in which a voice is output are established.

4. The dialogue system according to claim 3, wherein
the detection process includes a voice section detection process of detecting a section in which the voice is output, and
the state in which the voice is output in the predetermined state is a state in which the voice is determined to be in a voice section by the voice section detection process.

5. The dialogue system according to claim 1, wherein
the execution device further executes a display process of displaying an agent image by operating a display device,
the agent image is an image of an agent,
the agent is a person who dialogues with the user, and
the display process includes a process of displaying an image indicating the agent taking a posture of listening to the user when it is recognized by the recognition process that the user talks to the dialogue system.

6. The dialogue system according to claim 3, wherein
the execution device further executes
an utterance process of talking to the user by operating the speaker, and
a stop process of stopping the utterance process when it is recognized by the recognition process that the user talks to the dialogue system during execution of the utterance process.

7. The dialogue system according to of claim 6, further comprising:
a storage device, wherein
the execution device further executes a registration process, an authentication process, and a history information association process,
the registration process is a process of storing information on a face image of the user in the storage device by using the output signal of the camera as an input,
the authentication process includes a process of determining whether the user who is imaged by the camera is the user stored in the storage device, using the output signal of the camera as an input,
the history information association process is a process of storing, in the storage device, history information on communication between the user stored in the storage device and the dialogue system, and
the utterance process includes a process of determining a content of utterance based on the history information associated with the user authenticated by the authentication process.

8. The dialogue system according to claim 1, wherein
the execution device includes a first execution device and a second execution device,
the dialogue system further comprises a dialogue unit and a backend unit,
the dialogue unit includes the first execution device and a first communication device,
the backend unit includes the second execution device, a second storage device, and a second communication device,
the second storage device stores mapping data,
the detection process includes an output signal acquisition process, an image data transmission process, an image data receiving process, a state determination process, a determination result transmission process, and a determination result receiving process,
the output signal acquisition process is a process in which the first execution device acquires the output signal of the camera,
the image data transmission process is a process in which the first execution device operates the first communication device to transmit image data corresponding to the output signal of the camera to the backend unit,
the image data receiving process is a process in which the second execution device receives the image data,
the mapping data is data that defines a determination mapping,
the determination mapping is a process of outputting a variable used for determining whether the image data is in the predetermined state, using the image data as an input,
the state determination process is a process in which the second execution device inputs the image data to the determination mapping to calculate a variable related to a determination result of whether the image data is in the predetermined state,
the determination result transmission process is a process in which the second execution device operates the second communication device to transmit the variable related to the determination result to the dialogue unit, and
the determination result receiving process is a process in which the first execution device receives the determination result.

9. The dialogue unit included in the dialogue system according to claim 8.
